(19) United States
(12) Patent Application Publication
(10) Pub. No.: US 2010/0300618 A1
(43) Pub. Date: Dec. 2, 2010

(54) PRINTABLE AND CONDUCTIVE PASTE AND METHOD FOR COATING A MATERIAL WITH SAID PASTE

(75) Inventors: Gernot Frackmann, Grasellenbach (DE); Benno Schmied, Ludwigshafen (DE); Bjoern Hellbach, Weinheim (DE); Michael Roth, Mainz (DE); Gunter Scharfenberger, Frankenthal (DE); Ansagar Komp, Heidelberg (DE)

Correspondence Address: LEYDIG, VOIT AND MAYER, TWO PRUDENTIAL PLAZA, SUITE 4900, 180 NORTH STETSON AVENUE, CHICAGO, IL, 60601, US

(73) Assignee: CARL FREUDENBERG KG, Weinheim (DE)

(21) Appl. No.: 12/676,654

(22) PCT Filed: Sep. 4, 2008
(86) PCT No.: PCT/EP08/07235

§ 371 Date: Mar. 5, 2010

(30) Foreign Application Priority Data
Sep. 6, 2007 (DE) 10 2007 042 253.0

(51) Int. Cl. B32B 37/14; H01B 1/20; H01B 1/22; H01B 1/24; B05D 5/12

(52) U.S. Cl. 156/280; 252/500; 252/512; 252/514; 252/511; 427/58; 427/121; 977/932; 977/961; 977/742

(57) ABSTRACT

A printable and electrically conductive paste includes a dispersible thermoplastic polyurethane; an electrically conductive filler; a water-soluble thickener; and water.

This application is a U.S. National Phase Application under 35 U.S.C. §371 of International Application No. PCT/EP2008/007235, filed on Sep. 4, 2008, which claims priority to German Application No. DE 10 2007 042 253.0, filed on Sep. 6, 2007. The International Application was published in German on Mar. 19, 2009 as WO 2009/033602 under PCT Article 21 (2).

The invention relates to a printable and conductive paste containing a dispersion of a polyurethane in an aqueous solution, and to a method for coating a material with the paste.

### BACKGROUND

Such pastes are known from EP 1 284 278 A2. The aqueous coating composition contains a conductive powder in which a non-conducting core is coated with a conductive layer. Preferably, a core of glass is coated with silver. The pastes described therein are used, for example, for coating layers in sheet form, in particular textiles and nonwovens, and thus rendering them electrically conductive. Layers coated in that manner can be processed further to flexible strip conductors. It is also possible to provide layers with the paste in such a manner that they screen electromagnetic fields. A further field of application is the use of conductive textiles in clothing. The paste known from the prior art has the disadvantage that, owing to the binder, it is no longer stretchable and no longer thermally deformable after application to the material and hardening. Accordingly, a material coated with the paste is likewise not stretchable. The paste cannot therefore be used where the material is required to be stretchable.

A screen printing paste for electrically conductive coatings based on electrically conductive polymers is described in DE 197 57 542 A1.

US 2005/0224764 relates to electrically conductive inks containing carbon fibrils. Antistatic coatings for textiles are described in US 2004/0051082.

### SUMMARY OF THE INVENTION

An aspect of the invention is to provide an electrically conductive paste which is simple to process and is stretchable even after hardening.

In an embodiment, the printable and conductive paste comprises a dispersible thermoplastic polyurethane, a conductive filler, a water-soluble thickener and water. The thermoplastic polyurethane forms the binder for the paste and is both stretchable and thermally deformable. Accordingly, the paste is stretchable even after processing and can be reshaped at any time by thermal shaping processes, its stretchability being retained. The conductive filler is so added that the conductive particles are in contact with one another after processing and thus produce conductivity. The viscosity of the paste is determined by the water-soluble thickener. According to the invention viscosity is from 8000 to 150,000 mPas, preferably from 20,000 to 150,000 mPas, so that the paste can be applied to a material by a printing process, preferably screen printing or stencil printing.

Pastes according to the invention can preferably comprise from 2 to 40 wt. %, preferably from 4 to 25 wt. %, particularly preferably from 5 to 15 wt. % thermoplastic polyurethane. The amount of conductive filler is preferably from 2 to 40 wt. %, in particular from 15 to 40 wt. %, particularly preferably from 20 to 35 wt. %. Preferably from 1 to 5 wt. %, more preferably from 1.5 to 3 wt. %, thickener are present. Accordingly, in the dry substance, amounts of from 15 to 80 wt. %, preferably from 15 to 40 wt. %, thermoplastic polyurethane, from 15 to 85 wt. % conductive filler and from 0.5 to 4.5 wt. % thickener are obtained.

In a preferred embodiment, the thickener is provided in the form of an aqueous thickener solution. The thickener solution comprises, for example, from 1 to 5 wt. % of the thickener dissolved in water. Distilled or bidistilled water is preferably used. The amount of thickener paste in the pastes according to the invention is preferably from 40 to 80 wt. %, particularly preferably from 55 to 75 wt. %. The paste according to the invention is preferably water-based. It accordingly does not contain organic solvents or contains less than 2.1 or 0.5 wt. % organic solvents.

The surface resistivity of the paste after drying and calendering is preferably from 0.05 to 0.5 Ohm, the resistivity increasing by a factor of from 10 to 1000, depending on the composition, when the paste is stretched by 20 wt. %. The resistivity is lower, the higher the content of conductive filler. In order to improve its processability, the paste can contain auxiliary substances such as humectants and rheological additives.

The thickener can comprise or consist of cellulose derivatives, for example methylcellulose. Cellulose derivatives are chemical compounds derived from cellulose. A hydrophilic powder is obtained, which forms a viscous solution with water. Cellulose derivatives are non-digestible, non-allergenic and non-toxic and are therefore also suitable for the preparation of a paste for coating textiles for clothing. A suitable thickener of methylcellulose is, for example, Metylan® Normal (Henkel, Düsseldorf).

The paste according to the invention comprises thermoplastic polyurethanes (PU). Polyurethanes are formed substantially by the reaction of polyols (long-chained diols), diisocyanates and optionally short-chained diols. The nature of the starting materials. The reaction conditions and the relative proportions are responsible for the properties of the product. As polyols there are used in particular polyester polyols or polyether polyols. Methods are known to the person skilled in the art for choosing the starting materials and the reaction conditions so that polyurethanes having desired properties, for example melting point, density and hardness, are obtained. Thermoplastic polyurethane elastomers are also referred to as TPUs.

The thermoplastic polyurethane can have a melting point of from 80 to 220° C., in particular from 100 to 180 or from 110 to 150° C. Such polyurethanes can be used on textiles without problems and can be processed and shaped by conventional processes, for example calendering or deep-drawing. The melting point of the polyurethane is adjusted in the light of the desired processing method and the material to be coated. Therefore, depending on the application, higher-melting polyurethanes having melting points of approximately from 120 to 220° C., in particular above 130 or 140° C., or low-melting polyurethanes having melting points of approximately from 80 to 120° C., in particular below 110° C., are used. Polyurethanes do not usually have a clearly defined melting point but a melting range in which the material changes from the solid to the liquid state. According to the invention, the melting point refers to the temperature at which this melting process begins.

The polyurethanes can be aliphatic or aromatic. Aliphatic polyurethanes having a comparatively low melting range have the advantage that they are generally fast to light and do not yellow.

The polyurethanes are preferably stirred into the pastes in the form of fine powders, for example having mean particle diameters of <350 μm, preferably <200 μm or <120 μm, in particular from 20 to 350 μm, from 50 to 200 μm or from 80 to 120 μm. The small particle sue allows a homogeneous dispersion to be prepared, improves the printing behaviour and, owing to rapid melting, accelerates the preparation process.

In a preferred embodiment of the invention, the polyurethane used according to the invention does not contain free reactive groups, in particular free isocyanate groups. Such thermoplastic polyurethanes are obtained, for example, when the reaction between the polyol, the chain extender and the polyisocyanate is carried out with a stoichiometric excess of diol or polyol, so that the polymer contains only free, for example terminal, hydroxyl groups. In this embodiment, therefore, the polyurethane is not a reactive polymer but is hardened. Such a polyurethane does not react further under normal conditions and in aqueous solution. The polyurethane accordingly differs from commercially available prepolymers having free isocyanate groups. Such prepolymers are supplied, for example, in the form of dispersions.

According to the invention, the polyurethanes are used as binders, while the conductivity is brought about by the conductive fillers. Therefore, the paste according to the invention preferably does not contain conductive polymers. In a preferred embodiment of the invention, the polyurethanes are uncharged polyurethanes. The paste preferably contains only uncharged polyurethanes. Accordingly, no ionic polyurethanes are present. The paste according to the invention thus differs from the compositions of EP 1 284 278. Uncharged polyurethanes are generally not dispersible or only poorly dispersible in water. Pastes according to the invention containing uncharged polyurethanes are preferably suspensions in which polyurethanes in the form of solids are finely divided. The ionic polyurethanes that are used, for example, according to EP 1 284 278, on the other hand, are dispersed in molecular form in an aqueous solution. Commercial polyurethane dispersions (such as the brand ROTTA WS 80525 from Rotta GmbH) are conventionally prepared by dispersing a liquid and still reactive polyurethane prepolymer with very high shear using an emulsifier. Such a dispersion often still contains solvents, which are subsequently removed from the PU dispersion. The ionic groups of the polyurethane thereby increase the dispersibility and accordingly the storage stability, because settling of the polyurethane particles (density about 1.1) is prevented or greatly reduced because of mutual repulsion. Ionic polyurethanes, which result from the drying of these dispersions (still containing emulsifier), have the disadvantage that the water absorption and swelling in water is markedly higher than in the case of non-ionic polyurethanes on account of the hydrophilicity caused by the ionic groups.

In principle, ionic polyurethanes can also be used, according to the invention. If the viscosity of the (conductive) paste is so adjusted that sinking of the polyurethane particles and the copper flakes does not occur, neither the use of an ionic polyurethane nor the use of emulsifiers is necessary. In a preferred embodiment of the invention, the paste does not contain emulsifiers.

Thermoplastic polyurethanes that are suitable according to the invention can be prepared, for example, from the isocyanates diphenylmethane diisocyanate (MDI), such as 2,2′-, 2,4′- and/or 4,4′-diphenylmethane diisocyanate, hexamethylene-1,6-diisocyanate (HDI), isophorone diisocyanate (IPDI), toluylene diisocyanate (TDI), naphthylene-1,5-diisocyanate (NDI), dimethyl-diphenyl diisocyanate (TODI), dicyclohexyl-methane-4,4′-diisocyanate (HMDI).

Suitable polyols are polyethers, e.g. polytetrahydrofuran (PTHF) or polypropylene glycol (PPG), polyesters, e.g. ethylene adipate polyol, butylene adipate polyol, NPG adipates, polycarbonate polyols and polycaprolactone polyols, as well as polyether ester polyols.

These are optionally used in conjunction with suitable chain extenders. Suitable chain extenders are, for example, short-chained diols such as ethylene glycol, propanediol, butanediol, diethylene glycol, hexanediol cyclohexanedimethanol (CHDM), hydroquinone hydroxyethyl ether (HQEE) and diamines and, in small amounts, triamines or triols, for example trimethylolpropane.

Particular preference is given to the use of polyurethanes of ethylene glycol-adipic acid polyester polyol, butanediol, hexanediol and diphenylmethane-4,4′-diisocyanate. Such a TPU has, for example, a melting point of about 135° C.

For applications at lower temperatures, a TPU of, for example, polycaprolactone polyol and 1,6-hexamethylene diisocyanate is extended with the chain extenders: 1,6-hexanediol and 1,4-butanediol. In order to achieve melting temperatures of the TPU below 110° C., polyols of neopentyl glycol adipate and further isomers of butanediol can be added.

A suitable thermoplastic polyurethane can be prepared, for example, from the components methylene diphenyl isocyanate, polycarbonate/hexanediol-neopentyl glycol adipate and butanediol The thermoplastic polyurethane has a melting range of from 160 to 170° C. Such higher-melting polyurethanes in most cases have a Shore hardness of from 60 to 98 Shore(A) and, owing to their crystallisation behaviour, are suitable in particular for deep-drawing processes.

A further polyurethane comprises the components methylene diphenyl isocyanate, polycaprolactone and hexanediol. This thermoplastic polyurethane has a melting range of from 125 to 135° C. Low-melting polyurethanes in most cases have a Shore hardness of from 40 to 85 Shore(A) and are suitable in particular for use on low-melting textiles.

In an embodiment of the invention, the paste does not contain a crosslinker. No crosslinker is added before or during processing either. An uncrosslinked thermoplastic coating is thus obtained. The thermoplastic properties mean that deformation, is possible (for example by deep-drawing). Such an after-treatment is not possible with crosslinked polyurethanes, for example of conventional PU dispersion or those according to EP 1 284 278 A2. In a preferred embodiment of the invention, the polyurethanes in uncrosslinked pastes have a melting point above 120° C.

In a further embodiment of the invention, a crosslinker is present in the paste or a crosslinker is added before or during processing of the paste. In this embodiment the polyurethane contains crosslinkable hydroxyl groups. It is, for example, a polyurethane that has a low index, for example <99, <98 or <95, in particular >80, or from 80 to 98 (index=n(NCO)/n(OH)*100). In a preferred embodiment of the invention, the polyurethanes in crosslinked pastes have a melting point below 120° C., in particular below 110° C. The melting point is then, for example, from 80 to 120° C. or from 90 to 110° C. The crosslinker is a compound capable of linking hydroxyl groups, preferably a diisocyanate or polyisocyanate. The crosslinker is preferably a blocked isocyanate which has a crosslinking action only above a defined temperature, for example 70-140° C. The paste containing the crosslinker is preferably stable to storage at 25° or 40° C., i.e. no crosslinking occurs.

The melting point of the thermoplastic polyurethane can be adjusted to values below 120° C. to 110°C. by choosing suitable polyols and chain extender combinations. Such polyurethanes can be used when the substrate to be printed itself has a low melting point (e.g. in the case of a stretchable PU nonwoven). A melting point below 110° C. can be achieved, for example, with polycaprolactone polyol and additionally polyol of neopentyl glycol adipate and with the use of a plurality of chain extenders (1,6-hexanediol, 1,4-butanediol and 2,3-butanediol) as well as 1,6-hexamethylene diisocyanate. In order to increase the temperature stability of the coated materials it is possible to add a crosslinker to this low-melting paste. A crosslinker according to the invention that is added to these pastes is, for example, ground isocyanate, for example diphenylmethane-4,4′-diisocyanate (MDI) or 3,3′-dimethylbiphenyl-4.4′-diisocyanate (TODI), having a melting point below 110° C. In the aqueous paste, a thin urea layer forms on the isocyanate powder surface by reaction of isocyanate and water, with the result that the water permeability and accordingly the urea reaction within the isocyanate particles is slowed down very considerably. The paste is therefore stable to storage. In the calendering process, the polyurethane and the isocyanate melt and the crosslinking reaction of the isocyanate with the free OH groups of the polyurethane occurs. In this case, the crosslinkability is an advantage because sensitive substrates can be printed and the temperature stability of the coating is increased by the crosslinking reaction.

In preferred embodiments of the invention, the conductive filler is selected from metallic particles, carbon nanotubes, low-melting alloys and/or copper flakes.

The conductive filler can consist of metallic particles, preferably copper- and/or silver-based particles. Such metal-based particles have particularly good conductivity. In addition, copper- and silver-based particles are resistant to corrosion. The particles can be spherical, filiform or flat. The advantage of flat fillers is that, after pressure treatment, they are aligned parallel to one another and overlap. This results in a particularly low surface resistivity. Spherical particles are particularly easy to disperse. According to the invention, “metallic” particles refers to particles that consist largely or completely of metal, i.e. to the extent of more than 95%, >99% or to the extent of 100%.

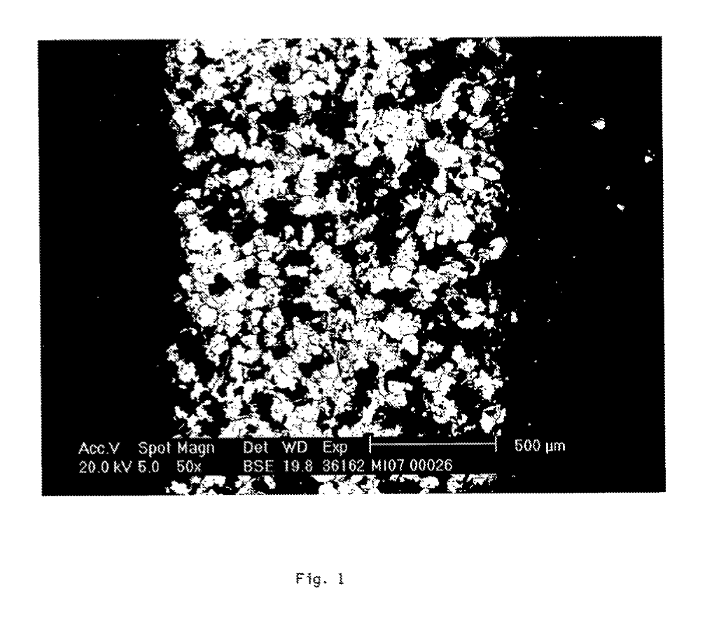

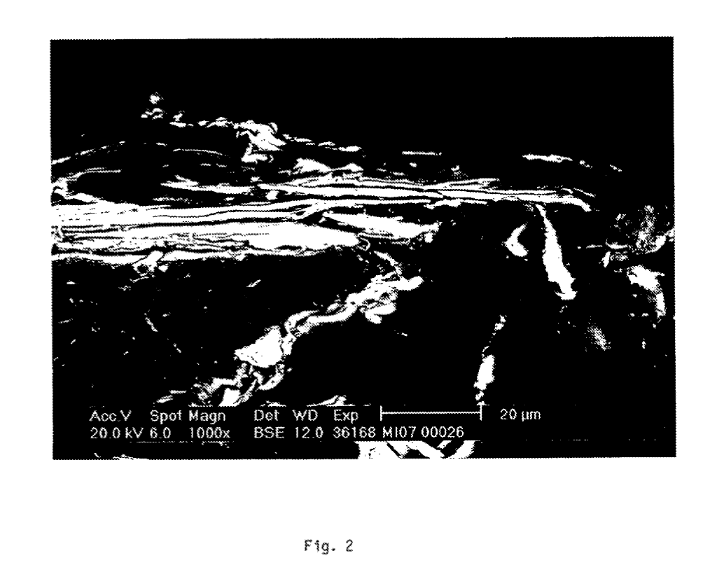

The conductive filler can comprise copper flakes. Copper flakes are flat particles. They can be aligned in parallel in a combined pressure and heat treatment. They can then also overlap one another and thus have a low surface resistivity. The copper flakes that can be used according to the invention have, for example, mean diameters of from 5 to 100 μm, in particular from 20 to 60 μm, and heights of from 0.2 to 10 μm, in particular from 0.5 to 8 μm. The copper flakes are preferably coated with a noble metal, in particular silver. The amount of the coating is preferably from 1 to 25 wt. %, in particular from 5 to 20 wt. %. Suitable copper flakes are obtainable, for example, under the trade mark Conduct-O-Fii SC230F9.5 (Potters Industries Inc.). These are flat copper flakes having a mean diameter of about 40 μm and a height of about 1-5 μm. The shape of the flakes will be seen in the REM photographs (FIGS. 1 and 2). They are silver-coated in an amount by weight of about 9-10 wt. %.

The conductive filler can comprise carbon nanotubes. Carbon nanotubes (CNTs) are tube-shaped structures made of carbon. They have a diameter of from 1 to 50 nm. The carbon nanotubes can be filled with metals, for example silver. Carbon nanotubes are distinguished by a high current carrying capacity. It is also conceivable to use metal-coated, for example silver-coated, glass fibres as the conductive filler.

The conductive filler can contain a low-melting alloy. Such an alloy is, for example, a tin-bismuth alloy. Such alloys melt when subjected to heat and pressure treatment, for example on calendering. The particles from the low-melting alloy can be mixed with other particles, for example of silver or copper. It is advantageous here that the other particles are bonded substance-to-substance by the low-melting particles and a particularly low surface resistivity is thus obtained. Within the scope of the invention, “low-melting” means that the alloy melts at the processing temperatures of the pastes, in particular from 100 to 220° C., from 100 to 180° C. or from 110 to 150° C.

In a preferred embodiment of the invention, the paste additionally comprises at least one antioxidant. There are suitable, for example, organic antioxidants, such as ascorbic acid, ascorbates such as sodium ascorbate or saccharides having a reducing action such as glucose, as well as inorganic antioxidants, such as metal salts having a reducing action, in particular reducing salts such as ammonium iron(II) sulfate. When preparing the paste according to the invention, an aqueous solution of the antioxidants in distilled water is preferably first prepared. This solution contains, for example, from 0.2 to 5 wt. %, preferably from 1.5 to 3 wt. %, antioxidants.

The preparation of the paste according to the invention is preferably carried out by first preparing an aqueous solution of the thickener and optionally the antioxidant (thickener solution). The thickener preferably swells while stirring is carried out for a sufficient time, for example from 10 to 30 minutes. A suitable viscosity is adjusted, for example from 1500 to 20,000 mPas.

The thermoplastic polyurethane, the conductive filler and optionally the crosslinker are then added and mixed by means of stirring to give a homogeneous paste. The paste is preferably degassed. If a crosslinker is used, it is preferably first mixed with the PU powder and/or the filler in order to achieve more homogeneous distribution.

In an embodiment of the invention, the paste has a pH value of from 6 to 8.5, preferably from 7 to 7.5. In a preferred embodiment, the pH value is approximately pH 7.0. These pH values are preferably also established when antioxidants are present. By adjusting the pH value within this range, by using antioxidants and by preparing and storing the pastes with, the exclusion of air, undesirable changes to the pastes can be avoided.

In the method according to the invention for coating a material with the paste according to the invention, the paste is printed onto at least one material and then dried, and the material printed with the paste is subjected to combined heat and pressure treatment.

The paste according to the invention permits application by means of printing processes. The printability is governed by the particle size and the viscosity of the paste, which is dependent on the content of thickener. By means of the pruning process, large surfaces can be printed simply and inexpensively with a reproducible pattern. Following the printing operation, the paste is dried, for example in a conveyor oven.

In a preferred embodiment of the invention, the paste containing the conductive particles is subjected to heat, and pressure treatment, preferably calendering, following drying. The paste is thereby consolidated, contact and adhesion with the material are improved, and the conductive particles are aligned. A smooth surface is formed, as well as an electrically conductive and stretchable coating of the material. In this treatment, the polyurethane melts and the copper flakes are temporarily “freely movable” in the PU matrix. The printed paste is consolidated on the substrate by the pressure that is applied. The compression aligns the thin flakes parallel to the applied pressure, they “flip over”. A structure is obtained in which the flakes lie virtually in one plane, whereby they overlap over the surface. This can be seen in REM photographs of the plates (see FIGS. 1 and 2). The alignment of the flakes has the effect that, even when the matrix is stretched, the flakes overlap, or are in contact, sufficiently, so that good conductivity is retained.

In a preferred embodiment of the invention, a material that has been provided with the paste is stretched in a thermal after-treatment. A deep-drawing process, for example, is suitable for this purpose. Stretching is thereby achieved, i.e. The PU matrix softens under pressure and heat and is spread. After cooling, it retains the stretched form. However, the silver-coated copper flakes still overlap sufficiently that electrical conductivity is retained. During the deep-drawing, the alignment of the flakes is improved further so that sufficient flakes still overlap even, when the substrate is spread or stretched.

The paste can be printed by means of screen or stencil printing. Depending on the choice of screen printing fabric, large layer thicknesses of the printed paste are possible.

Following the combined heat and pressure treatment, the material with the printed paste can be thermally deformed. An advantage of using a thermoplastic polyurethane is that such pastes can be reshaped at any time by melting the polyurethane. Therefore, even the materials already provided with the paste can repeatedly be reshaped later.

It is possible to provide a plurality of materials with the paste and join them together substance-to-substance via the paste by pressure and heat treatment. Textiles can thereby be conductively joined to one another. This is advantageous in the case of items of clothing in particular, because the conductive and substance-to-substance joining of a plurality of clothing pieces is possible by simple means.

Materials coated with the paste according to the invention are suitable in particular for automotive applications, for example dashboards and roof linings that have a three-dimensional, curved geometry, the material provided with the paste being deformed thermally and assuming the shape of the material. Furthermore, the paste according to the invention is suitable for use in clothing, in particular functional clothing with integrated electronic components. The paste here forms flexible strip conductors on the clothing. Furthermore, use in medical clothing and medical aids is also conceivable. A further field of use is in the functional coating of equipment and pipelines, it is also conceivable to provide antistatic properties using the paste according to the invention or to use the paste for applications in heating/refrigeration.

### BRIEF DESCRIPTION OF THE DRAWINGS

The figures show REM photographs of a nonwoven which has been printed with the paste according to the invention and subjected to a subsequent combined heat and pressure treatment.

### DETAILED DESCRIPTION

In the following implementation examples, the following measuring methods were used:

The viscosity is determined by means of a Brookfield viscometer according to DIN EN ISO 2555 (resins in the liquid state, in the form of emulsions or dispersions: determination of the apparent viscosity by the Brookfield method; spindle 6 or 7 depending on the viscosity; speed; 20 rpm).

The surface resistivity is determined over a straight, rectangular structure (strip conductor), the mean layer thickness of which is calculated via one or more micrographs. Because the nonwoven does not form a closed surface, some of the paste penetrates into the open surface (see REM photographs), coats the fibres and therefore has a layer thickness which is variable within certain limits. The electrical conductivity/the resistivity are measured using a four-point method in order to avoid measuring errors due to contact resistances.

The tensile strength of plastics (stretchability) can be determined by the method of DIN 53504 or, for foils, better according to ISO 527-3. The stretching rate is set at 1%/sec.

The determination of the stretch (until conductor breakage) is carried out correspondingly to the determination of the stretchability, the electrical conductivity being measured at the same time by bringing the strip conductor into contact with a measuring device. In the case of the present conductors, conductor breakage is regarded as being the increase in the resistance by three orders of magnitude. The maximum stretch achieved on conductor breakage is referred to as the stretch.

The melting range is determined by means of a Kofler bench.

### Example 1

A non-ionic, thermoplastic, uncrosslinked, OH-terminated polyurethane is used as the polyurethane. This is prepared from ethylene glycol-adipic acid polyester polyol and diphenyl methane-4,4′-diisocyanate with the addition of the chain extenders butanediol and hexanediol. The index, which describes the ratio of isocyanate groups to hydroxyl groups in the polymer, is below 100. The TPU has a melting point of about 135° C. and is used in the form of a fine powder. To prepare the paste, an aqueous solution of the thickener methylcellulose (Metylan Normal®, Henkel) is prepared, with stirring. The thickener thereby swells with stirring for a further 20 minutes. Depending on the concentration of the thickener, the aqueous solution has a viscosity of from 1500 to 20,000 mPas. The TPU powder and the conductive filler are stirred into the solution, and the mixture is processed to a homogeneous paste, with further stirring, and then degassed in vacuo. When a crosslinker is used, it is weighed together with the PU powder and/or the filler and mixed in. When antioxidants are used, an approximately 2.8% solution having a pH value of 7.0 is first prepared using fully demineralised water, and the thickener is stirred into the solution.

A first example of a paste according to the invention contains 60 wt. % of a solution consisting of 1.5% Metylan® Normal (Henkel KGaA) in water, 32 wt. % of a conductive filler, in this embodiment silver-coated copper flakes (Conduct-O-Fil, SC230F9.5 from Potters Industries Inc.) and 8 wt. % of a thermoplastic polyurethane having a particle size less than 120 μm.

The paste has a viscosity of 56,000 mPas and can be printed onto a material by means of screen printing, for example. After drying in an oven and after-treatment in a heated calender, the paste as a dry solid has a surface resistivity of 0.19 Ohm.

### Example 2

A paste was prepared according to Example 1, the following different conditions being established. The paste according to the invention contains 70 wt. % of a solution consisting of 2.1% Metylan® Normal (Henkel KGaA) in water, 24 wt. % of a conductive filler, in this embodiment silver-coated copper flakes, and 6 wt. % of a thermoplastic polyurethane having a particle size less than 120 μm.

The paste has a viscosity of 50,200 mPas and can be printed onto a material by means of screen printing, for example. After drying in an oven and after-treatment in a heated calender, the paste as a dried solid has a surface resistivity of 0.44 Ohm.

### Example 3

A paste was prepared according to Example 1, the following different conditions being established. The paste according to the invention contains 60 wt. % of a solution consisting of 2.5% Metylan® Normal (Henkel KGaA) in water, 32 wt. % of a conductive filler, in this embodiment copper flakes, and 8 wt. % of a thermoplastic polyurethane having a particle size less than 120 μm,

The paste has a viscosity of 125,000 mPas and can be printed onto a material by means of stencil printing, for example. After drying in an oven and after-treatment in a heated calender, the paste as a dried solid has a surface resistivity of 0.39 Ohm.

In Examples 2 to 4, a stretchability of the dried and calendered paste of up to 25% is obtained. The stretchability of the paste is limited predominantly by the pronounced increase in the resistivity.

The REM photographs in FIGS. 1 and 2 show a nonwoven which has been printed with the paste and subjected in a calender to subsequent heat and pressure treatment. On calendering, the polyurethane particles were melted and the metallic flakes were aligned and overlap one another, which improves the conductivity. The thermoplastic polyurethane, as binder, binds the particles together and to the nonwoven.

### Example 4

Various suitable polyurethanes were prepared. Table 1 shows an overview of the components used. The melting range can be varied by the choice of components.

TABLE 1

| | | | Chain extender | |
|---|---|---|---|---|
| Ref. | Isocyanate | Polyol(s) | (molar ratio) | Melting range |
| PU1 | MDI | D2028 | B/H 80:20 | |
| PU2 | MDI | D2000 | B/H 80:20 | 130-135 |
| PU3 | MDI | D2000 | B/H 80:20 | 150-155 |
| PU4 | MDI | D2000 | B/H/D: 80:10:10 | 130 |
| PU5 | MDI | D2001 KS | B/H 75:25 | from 145 |
| PU6 | MDI | DG200 | B/H/N 80:10:10 | from 135 |
| PU7 | MDI | C200 | none | 205 |
| PU8 | MDI | T2000 | B/H/N 80:10:10 | 165 |
| PU9 | MDI | DG200 | B/H 75:25 | 165 |
| PU10 | HDI | C2200 | B/H 50:50 | 112-117 |
| PU11 | HDI | C2200/D2028 | 2,3-B/H 58:42 | 100-105 |
| PU12 | HDI | C2200/D2028 | 1,4-B/2,3-B/H | 95-100 |
| | | | 29:29:42 | |

Abbreviations;

Base Polyols:
D: Desmophen™ (polyols from Bayer)
D2000; polyethylene adipate diol (Mw: 2000)
D2001 KS: polyethylene/polybutylene adipate diol (Mw: 2000)
D2028; neopentyl glycol adipate (Mw: 2000)
C: Capa™ (polycaprolactone polyols from Solvay)
C200 polycaprolactone (Mw; 535)
C2200; polycaprolactone (Mw: 2000)
DG Diexter™ G (polyols from Coim)
DG200: saturated polyesterol adipate
T: Terathane™ (polyether polyol from Invista)
T2000: polytetramethylene ether glycol

Chain ext.: B: butanediol (1,4-B: 1,4-butanediol); H: 1,6-hexanediol; D: diethylene glycol (3-oxapentane-1,5-diol); N: neopentyl glycol (2,2-dimethyl-1,3-propanediol)

Isocyanates; MDI: diphenylmethane-4,4′-diisocyanate (methylene di(phenyl isocyanate)); HDI: 1,6-hexamethylene diisocyanate

The aliphatic polyurethanes PU10, PU11 and PU12 are particularly suitable for the preparation of pastes having a low melting range. They are fast to light and non-yellowing and are therefore suitable inter alia for applications in the visible range. Polyurethanes PU1 to PU9 are aromatic polymers.

### Example 5

The properties of further printed and dried pastes containing various polyurethanes are tested. The resistivity in the initial state is measured. In addition, the stretch until conductor breakage is measured in % (based on the original length). The conductor had a length of 90 mm and an overall width of 22 mm. The result is shown in Table 2:

TABLE 2

Type

| | 1 | 2 | 3 | 4 |
|---|---|---|---|---|
| R [Ohm] | 1.0 | 0.4 | 0.35 | 2 |
| ε [%] | 22 | 27 | 13 | 13 |

Type 1: Paste according to Example 1 using TPU PU2 (see Table 1), but using 20% TPU and 20% conductive filler (Conduct-O-Fil).
Type 2: Paste according to Example 1 using TPU PU2 (see Table 1).
Type 3: Paste according to Example 1 using TPU PUS (see Table 1).
Type 4: Paste according to Example 1 using TPU PUS (see Table 1), but using 20% TPU and 20% conductive filler (Conduct-O-Fil).

### Example 6

Pastes containing antioxidants were prepared. To this end, 2.45 g of ascorbic acid were dissolved in 98.5 g of water and the pH value was adjusted, with NaHCO₃ to a value of pH 6.5 to 7.5. 1.5 g of Metylan® Normal were added. The paste was then prepared by addition of 16.67 g of polyurethane and 50 g of copper flakes (Conduct-o-fil). Alternatively, ammonium iron(II) sulfate or glucose can be used as antioxidant. A suitable batch contains 60 g of aqueous 1.5% Metylan solution, 30 g of Cu flakes, 10 g of TPU and from 0.5 to 3 wt. % antioxidant.

1-15. (canceled)

16. A printable and electrically conductive paste comprising:
a dispersible thermoplastic polyurethane;
an electrically conductive filler;
a water-soluble thickener; and
water.

17. The paste as recited in claim 16, wherein the thickener includes cellulose derivatives.

18. The paste as recited in claim 16, wherein the thermoplastic polyurethane is an uncharged polyurethane.

19. The paste as recited in claim 16, wherein the thermoplastic polyurethane includes particles having a particle size less than 350 μm.

20. The paste as recited in claim 19, wherein the particle size is less than 120 μm.

21. The paste as recited in claim 16, wherein the thermoplastic polyurethane has a melting point between 100° C. and 220° C.

22. The paste as recited in claim 16, wherein the electrically conductive filler includes metallic particles.

23. The paste as recited in claim 22, wherein the metallic particles include at least one of copper-based and silver-based particles.

24. The paste as recited in claim 16, wherein the electrically conductive filler includes copper flakes.

25. The paste as recited in claim 16, wherein the electrically conductive filler includes at least one of carbon nanotubes and a low-melting alloy.

26. The paste as recited in claim 16, wherein the thermoplastic polyurethane includes free hydroxyl groups and the paste includes a crosslinker.

27. A method for coating at least one material, the method comprising:
providing a paste including a dispersible thermoplastic polyurethane, an electrically conductive filler, a water-soluble thickener and water;
printing the paste onto the at least one material;
drying the paste; and
subjecting the at least one material with the paste to a combined heat and pressure treatment.

28. The method as recited in claim 27, wherein the printing is performed using one of screen and stencil printing.

29. The method as recited in claim 27, further comprising thermally deforming the at least one material following the combined heat and pressure treatment.

30. The method as recited in claim 27, wherein the at least one material includes a plurality of materials, and further comprising joining each of the plurality of materials together via the paste before the treatment.

31. The method as recited in claim 27, wherein the at least one material includes a fabric.

32. The method as recited in claim 31, wherein the fabric is a nonwoven.

33. The method as recited in claim 31, wherein the fabric is an item of clothing.
